(19) United States
(12) Patent Application Publication
(10) Pub. No.: US 2005/0171704 A1
(43) Pub. Date: Aug. 4, 2005

(54) Method for the automated quantification of power production, resource utilization and wear of turbines

(76) Inventors: Bradley M. Lewis, Pulaski, VA (US); Patryk A. Laurent, Pittsburg, PA (US); Andrew G. Poush, Ronaoke, VA (US)

Correspondence Address: James W. Hiney, Esq., Suite 1100, 1872 Pratt Drive, Blacksburg, VA, 24060, US

(21) Appl. No.: 10/767,802

(22) Filed: Jan. 29, 2004

(51) Int. Cl. G06F 19/00

(52) U.S. Cl. 702/33

(57) ABSTRACT

A technique and system for the quantitative and systematic processing and analysis of data emanating from various models of controllers connected to power-generating devices which produce digital and analog data related to their production of power.

### BACKGROUND OF THE INVENTION

Progress in information technology has proceeded at an incredible rate, but little of this technology has been applied in innovative ways to solve data collection and reporting problems suffered by the electric power industry. Hardware already exists to collect large quantities of data but a tremendous portion of this data is discarded or stored without analysis because of the lack of means to systematically organize and process it.

The present invention relates to a systematic technique for the quantitative and systematic processing and analysis of data emanating from various models of controllers connected to power-generating devices which produce digital and analog data related to their production of power.

Accurately measuring power production and estimating asset wear, in terms of a standard metric like Equivalent Hours and Equivalent Starts (see Glossary) is critical in order to precisely calculate component life, optimize maintenance schedules and directly determine the profitability of electric power producing enterprises. The present invention provides a mechanism for optimally and automatically performing these calculations.

Glossary

Adjustment: The value for one or more turbine controllers which should be added to an unscaled value after it has been multiplied by gain.

Alarm: A type of data which, when requested from a turbine controller for a particular turbine, returns signals consisting of symbolic alarm names, and the new state of the alarm. Alarms are different from events in that signals are received form both when the alarm is inactivated, as well as in a different way when the alarm is reset (When the situation is no longer present). Persisting alarms may also periodically be emitted. An example of an alarm is overheating, which may have critical hearing on Equivalent Hours.

Data Historian: A computer which resides on a network with turbine controllers and preserves data emitted by a particular subset of the turbines for a pre-specified duration of time. Alternatively, data historians may alternatively preserve as much information as possible due to their own storage constraints, irrespective of time duration.

Data Point: A type of data which, when requested from a turbine controller for a particular turbine AND symbolic name (for example, AMBIENT_TEMPERATURE), is provided on a periodic basis to the requesting application in the form of values. Data points are periodically polled, regardless of whether they changed, and may therefore return the same value each time if what they measure hasn't changed.

Equivalent Starts: A metric that can be used by itself or in conjunction with Equivalent Hours to predict turbine maintenance. Calculated by weighting and summing the following: number turbine starts, starting fuel, particular failures, particular trips. The present invention has a lookup table which is calibrated with the factors appropriate to each turbine type being monitored. Once Equivalent Hours has reached a certain number service/maintenance is required.

Event: A type of data which, when requested from a turbine controller for a particular turbine, returns signals consisting of symbolic alarm names, and the new Boolean (true or false) state of an event. An example of an event is Breaker Open (where an event named L52GX is true).

GE Standard Messaging (GSM): GSM is an example of a communications protocol supported by some Turbine Controllers (see Glossary) which permits sending requests for and receiving responses regarding turbine data form turbine controller. GSM messages can be sent to request data from the 3 different kings of data pathways supported by turbine controllers.

Gain: The value of one or more turbine controllers by which an unscaled data value must be multiplied by before having adjustment added to it in order to produce scaled data.

Human Machine Interface (HMI): A computer which resides on a network with turbine controllers and allows the turbine controllers to be contacted via TCP/IP.

Pathway: At least three kinds of information can be requested about turbines over the network through access to turbine controllers. The set of requests to and responses from turbine controllers, each of which includes a specific label indicating the kind of information contained, is termed a pathway. Pathways can have certain characteristics, such as buffering (where in the case of restoration after network failure, data flow is resumed from where it was left off), periodicity or event-driven.

Scaled Data: Data values which are relevant to engineers such as meters, seconds, watts, etc.

TCP/IP: A standard communications protocol, which is frequently used across the internet as well as in local area networks (LANs), which ensures that packets of data transmitted are all received at the correct destination, and in proper order.

Turbine Controller: A specialized piece of hardware that is an intermediary between the turbine's hardware and electronic systems to collect data from the turbine.

Unscaled Data: Data which are only relevant in an abstract sense to the controllers from which the data emanated; this data has no units.

### SUMMARY OF THE INVENTION

The present invention can be described as a 3-layer processing system. The first layer, the Data Translation Layer, aggregates and translates event driven data (such as controller events and alarms) and periodic data (such as controller data point values polled every 30 sec) for various turbines to a common essential set suitable for automated computation, which common set is augmented in its reliability through use of redundancy. The second layer, the Interval Determination Layer, uses the translated data from the first layer to perform multiple interval demarcation for intervals of interest to each turbine operation. The third layer, the Multi-interval Integration Layer is where counting, sum, integral, and rate calculations take place over the intervals sent from the second layer.

The present invention requires that data relevant to turbine operations (see Glossary) be provided in an accurate and preferably timely fashion. In a preferred use, the data would be provided in real-time. Optionally the invention can also be used post-operationally when combined with a database which contains a record of the relevant data.

Data from turbine controllers is variously available through at least 3 principle data pathways: events pathway, alarms pathway, and data points pathway (see Glossary). Among these 3 different pathways, there is some level of redundancy for the most critical data. Due to differences in the way these pathways operate, it is possible that one of these pathways is disrupted but others remain operational. In cases where a partial disruption occurs, the present invention is able to pool the data available to it in order to make decisions about turbine operations. The result is a device with increased reliability.

In the case of temporary network interruptions while the algorithm is executing for a turbine, an explicit message indicating loss of communications is recorded into a log. In these rare cases which are explicitly marked, human intervention may needed to verify and/or correct the numbers provided by the algorithm.

At the core of the present invention is an algorithm to automatically determine critical intervals corresponding to operations and perform integrations, averages, and counts. These are described in the following text.

In summary, the present invention
Collects data from various kinds of turbines and turbine controllers.
Is capable of providing the same in-depth report for each.
Takes into account redundancies in available data, increasing reliability of the automated process.
Analyzes and tabulate in a very accurate way data relevant to turbine operations.
Can be operated in real-time or post-operationally.
Is adaptable to any electric power producing asset.

### DESCRIPTION OF THE DRAWINGS

FIG. 1 illustrates a network in which the present invention could operate. The present invention can be described as a 3-layer processing system, as depicted in

FIG. 2. The first layer termed the Data Translation Layer consists of a database containing names of equivalent points and formulas for those points in order to provide base data to the Interval Determination Layer algorithm. The Data Translation Layer is able to normalize various designs and specifications of turbines to a common base for the sole purpose of processing by the invention. That is, there exist many possible normalizations of the available data, but the normalization used here must maximally preserve the information required for the downstream processes in this invention.

In FIG. 3, functions of the first layer, called the Data Translation Layer are illustrated with some simple examples.

In FIG. 4, functions of the second layer, called the Interval-Determination Layer are illustrated with a simple example. It consists of a series of switches that are sensitive to the ordering of the transitions of various points provided by the Data Translation Layer. These switches are also attuned to possible redundancies in incoming data. An example of such a switch is Breaker Closure, which defines the smallest integration interval.

There is no figure in which the third layer Multi-interval Integration Layer functionality is illustrated. It is a trivial set of functions providing summation facilities to the present invention, given the interval endpoints and the values to be integrated, which are typically instantaneous measurements of fuel consumption or of power generation.

FIG. 5 represents summary data that can be included in reports as a result of all the intelligence gathered by ART.

### DETAILED DESCRIPTION OF THE PREFERRED EMBODIMENTS

The present invention can be implemented in a programming language capable of supporting networking communication, such as over a LAN or the internet, or any other kind of computer network.

Inputs to the present invention include data values over a network provided by turbine controllers, data from a database which forms the basis of the Data Translation Layer, data from another invention which is able to indicate the states of the turbine, and data from another database containing a history of the points received by the present invention to-date (within a relevant time-frame).

The Data Translation Layer typically requires the use of interpreting and evaluating formulas in the case that two or more data values provided by the controller must be aggregated in a formulaic way in order to obtain a data value relevant to the present invention. Because information from turbines can come from multiple pathways, redundancies are handled by a special layer which is capable of distinguishing whether several different signals represent, in fact, the same event. The algorithm makes this judgment based on the fact that signals from a particular event will A) all be emitted within a particular window of time, and B) all be related in a way that is obvious to someone versed in turbine operations. For example, compressor speed and fuel consumption rising above zero around the same time indicate the same event (e.g., that the turbine is starting up). And, in the case that one or more measurement devices have failed, either one of the signals is sufficient indication that the turbine is in the process of starting up.

In an example of a preferred embodiment, the invention actively monitors its Data Translation Layer, which relays the data values provided by the turbine controllers over the communications network. A look-up table indicating the current states of each turbine is maintained by the invention. When data indicating the start of a turbine is indicated, the invention notes this in its look-up table, as well as the time of the start event. The turbine is then qualified for breaker state changes, such as breaker openings and closures. Breaker openings and closures are also recorded in a look-up table. Between and during breaker closures, data is monitored through the Data Translation Layer for changes in fuel type as well as possible failures of the turbine to maintain Megawatt production, such as “trips”. In order to calculate the wear on the machinery, information on temperature and speed of mechanical movement is collected. At the time of turbine operation termination, information collected for the operation up to that point is summed, integrated and counted and a report is written periodically to a database through which a device such as a computer-accessible web-based user interface provides information to one or more end-users. The interface provides information on each turbine, whether operating or not, and can display information on an entire fleet of turbines connected to the system.

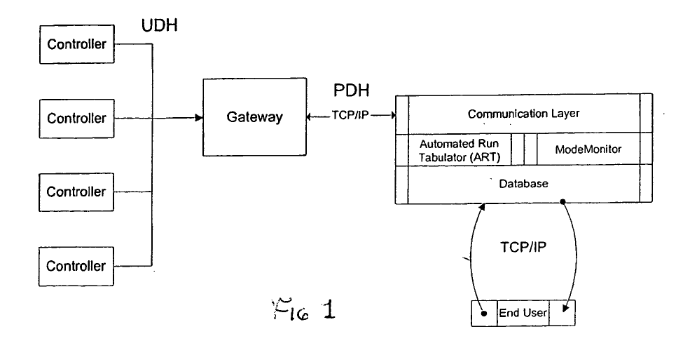

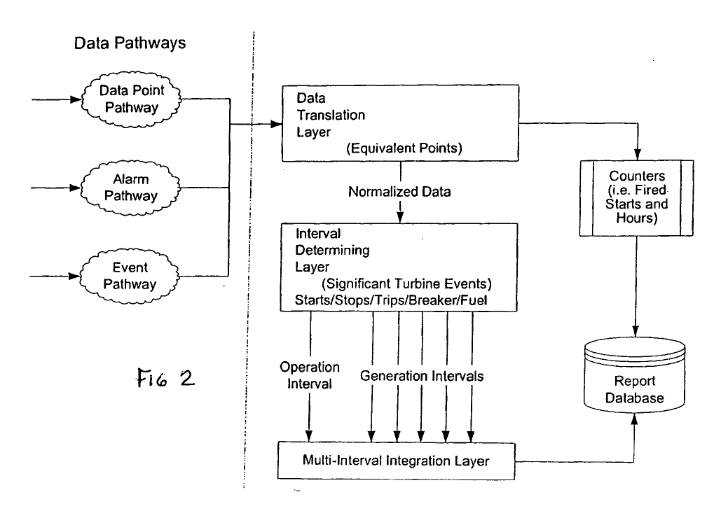

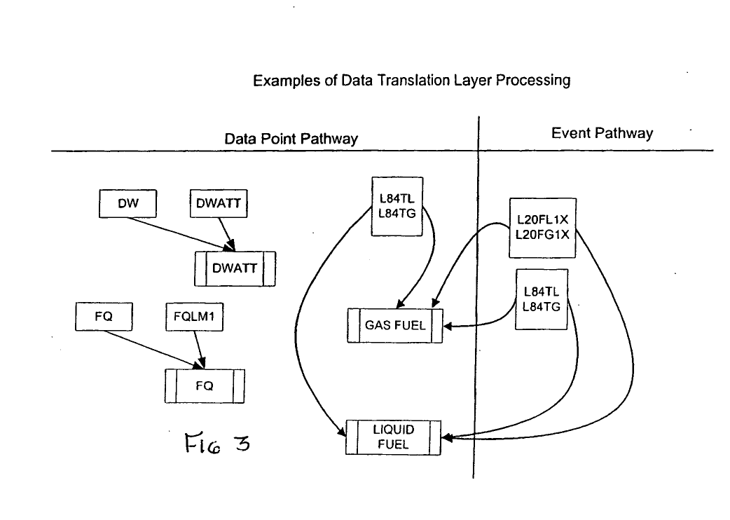

FIG. 1. Simple example network in which the present invention, here named “Automated Run Tabulator,” for illustrative purposes, can operate. Arrows indicate data flow from the turbine controllers onto the Unit Data Highway (UDH). (FIG. 1 implies controllers directly connected to the UDH, but there may be PLCs or other devices interposed between the controllers and the UDH.) The data on the UDH then comes through a UDH Gateway (generally a real-time HMI computer device, Data Historian computer, or other computer that can serve requests for process data) which makes the data available over a Plant Data Highway (PDH) network (using TCP/IP protocol in this example). The Communication layer (developed by SUPER natural tools, Inc.) gathers data via the PDH issuing requests to the Gateway and reading responses. (There are many variations on network topologies that cannot be shown here for the sake of brevity. The invention can be applied to any topology and take advantage of redundancies in gateways, unit and plant data highways, and controllers.)

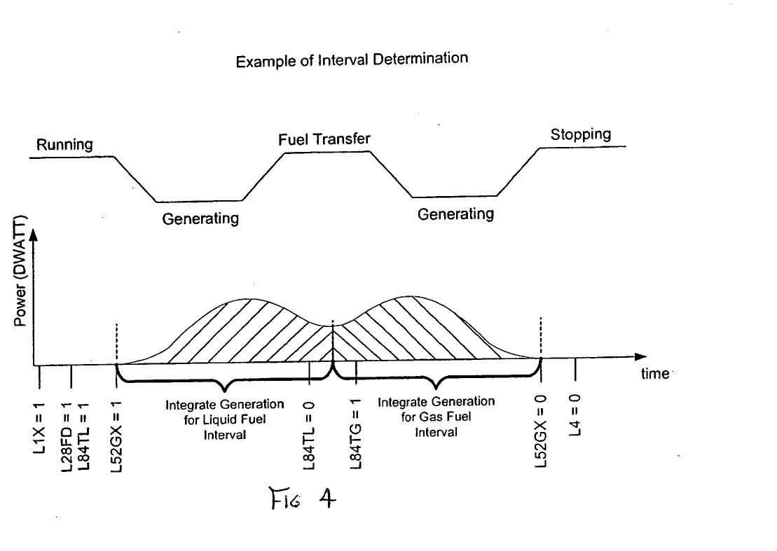

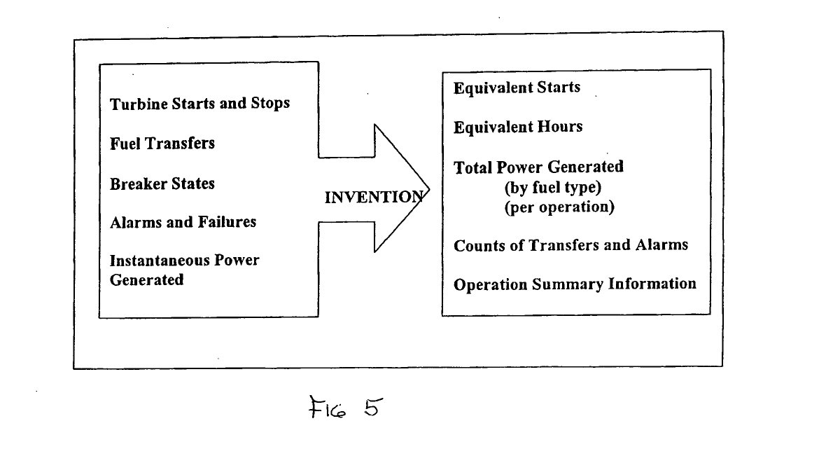

FIG. 2. Basic structure of the present invention. The Data Translation Layer, interval determining layer, counters/equivalent starts component and the multi-interval integration layer (which provides simple single, double and triple integration of data over time) are depicted here.

FIG. 3. Examples of Data Translation Layer Processing. To provide a uniform basis for calculating fuel usage on all turbines, the Data Translation Layer normalizes the names and types of data. Data from differing pathways are translated into each relevant point used in the algorithm. In the illustration below, we show some of the possible aggregations: DW or DWATT, indicating Megawatts Produced, is the same point on two different turbine models. And similarly for FQ and FQLM1 which, for example, indicate liquid fuel flow rate. Point values from different pathways can also be aggregated, as in the examples for L84TL and L84TG, which help determine whether a turbine is consuming Liquid Fuel (such as #2 heating oil) or Gaseous Fuel (such as natural gas).

FIG. 4. Illustration of Interval Determination. The present invention takes into account several boundaries to perform the triple integrations involved in determining fuel usage. Determining intervals is important so the power generated can be associated with the appropriate fuel type. The x-y plot here shows an example of two integration intervals of interest with respect to power generated. The signals listed under the x-axis are normalized output from the Data Translation Layer. And the pulse train above the plot is just for qualitative illustration of the sequence of events.

FIG. 5. Summary of data processing and reporting in the present invention. Instantaneous and single measurements on the left are counted by the invention in an automated fashion in order to produce reportable quantities which can be used by control engineers to determine wear and usage of turbines.

1. A method for tracking and monitoring turbines for determining data for quantification of their operation, said method comprising
furnishing a system for tracking and calculating values relevant to the operation of turbines,
calculating precise automated quantification of said data for determining the optimum settings for operation of said turbines.

2. A method as in claim 1 wherein said step of calculating includes calculating production of power characteristics.

3. A method as in claim 1 wherein said step of calculating includes calculating consumption of fuel characteristics.

4. A method as in claim 1 wherein said step of calculating includes calculating wear determination on said turbines.

5. A method as in claim wherein said system includes a network comprising combinations of communications protocols such as TGP/IP, GSM, and others.

6. A method as in claim 1 wherein said system includes a web-based management and information sub-system which reflects up-to-date measurements and status information on turbines.

7. A method as in claim 1 wherein said system includes a subsystem capable of storing data obtained through various communications protocols, which can be used to quantify data from a turbine after the operation has occurred.

8. A method as in claims 5, 6 and 7 wherein information is collected from one or more turbines for the purpose of creating generated comparative performance ratings between said turbines.

9. A system for tracking and calculating values relevant to the operation of power-generating devices which produce digital and analog data related to their production of power, said system comprising
means to track the quantitative data emanating from a series of controllers connected to said power-generating devices, said controllers producing analog and digital data related to their production of power,
means to optimally and automatically determine values relevant to the analog and digital data produced by said controllers so as to precisely calculate information critical to successful operation of said power-generating devices.

10. A system as in claim 9 wherein said means to determine values can calculate values relevant to the production of power, consumption of fuel and determination of wear.

11. A system as in claim 10 wherein said power-generating devices are turbines.

12. A system as in claim 10 wherein said power-generating devices include combustion turbines including jet engines, steam turbines, helicopters, hydroelectric, geothermal, wind, solar, nuclear and similar power-generating devices which product analog and digital data related to the production of their power though the movement of physical substances and/or mechanical components.

13. A system as in claim 10 wherein said system includes a network constructed of various combinations of communications protocols such as TCP/IP, GSM and others.

14. A system as in claim 10 wherein said system includes a web-based management and information capture system which reflects up-to-date measurements and status information on turbines.

15. A system as in claim 10 wherein said system can operate on combustion turbines including jet engine turbines, steam turbines, helicopters, hydroelectric, geothermal, wind solar, nuclear and similar power-generating devices which produce digital and analog data related to the production of their power.

16. A system as in claim 10 wherein said system includes a database sub-system capable of storing data obtained through various communications protocols, which can be used to quantify data from a turbine after the operation has ceased.

17. A system as in claim 10 wherein said system has a first Data Translation Layer.

18. A system as in claim 17 wherein said system has a Second Layer of Interval Determination.

19. A system as in claim 18 wherein said system has a Multi-interval Third Integration Layer.
